(19) United States
(12) Patent Application Publication
(10) Pub. No.: US 2024/0343176 A1
(43) Pub. Date: Oct. 17, 2024

(54) RECREATIONAL VEHICLE WITH AT LEAST ONE CHANGEABLE SEAT DEVICE IN THE FRONT AREA

(71) Applicant: HYMER GmbH & Co. KG, Bad Waldsee (DE)

(72) Inventors: Andreas Fiedler, Neu-Ulm (DE); Stefan Ziegler, Erfurt (DE); Sylvia Menailiuk, Weingarten (DE)

(21) Appl. No.: 18/613,479

(22) Filed: Mar. 22, 2024

(30) Foreign Application Priority Data
Mar. 22, 2023 (DE) 10 2023 107 255.2

(51) Int. Cl. B60N 2/72; B60N 2/14; B60N 2/22; B60N 2/34

(52) U.S. Cl. CPC B60N 2/72; B60N 2/143; B60N 2/22; B60N 2/34; B60N 2002/2204

(57) ABSTRACT

A recreational vehicle has at least one seat device in the front region, which can be arranged in a driving position for driving the recreational vehicle and in at least one rest position different from the driving position. At least one upholstery extension is provided and the upholstery extension is designed in such a way that it fits into the at least one seat device at least in the rest position.

### CROSS-REFERENCE TO RELATED APPLICATION

This application claims priority to German application DE 10 2023 107 255.2, filed Mar. 22, 2023, which is hereby incorporated by reference in its entirety.

### FIELD OF THE INVENTION

The invention relates to a recreational vehicle, in particular a motorhome, with at least one adjustable seat device in the front region. In particular, the invention relates to the field of recreational vehicles in which the driver's seat and the passenger seat can each be rotated by at least 180° for a stay at a campsite, for example, in order to enable use for residential purposes.

### BACKGROUND OF THE INVENTION

A motorhome is known from EP 0 844 135 A2. The front seats of the motorhome are designed to rotate so that the seating position not only faces forwards towards the windscreen, but can also face backwards and sometimes even at an angle to the rear. There is also a seat group consisting of a single seat and a bench seat. In the space between all these seats, a table is attached to the floor, which consists of a single-column frame and a table top mounted on it so that it can rotate off-centre. The rotatable table top can be locked in different rotational positions. Furthermore, a lifting bed can be swivelled over the front seats from a sideways or upwardly swivelled non-use position.

The motorhome known from EP 0 844 135 A2 has the disadvantage that the space required for the arrangement consisting of the seats and the table is large when viewed in plan. Furthermore, the fold-down bed arranged above a front seat requires additional storage space if the arrangement consisting of the seats is to be used. A further disadvantage is the restrictions on the layout associated with the arrangement, in particular the arrangement of a side door of the motorhome.

### SUMMARY OF THE INVENTION

The object of the invention is to provide a recreational vehicle, in particular a motorhome, which has an improved structure and enables improved operation.

The object is achieved by a recreational vehicle with the features disclosed herein. Advantageous further embodiments of the invention are also disclosed.

The problem is solved by a recreational vehicle, in particular a motorhome, with at least one seat device in the front region, which can be arranged in a driving position for driving the recreational vehicle and in at least one rest position different from the driving position, wherein at least one upholstery extension is provided and wherein the upholstery extension is designed in such a way that it fits into the at least one seat device at least in the rest position.

It is possible for the seat device to be movable into several different positions.

It is advantageous that at least one upholstery extension is designed as a seat surface support and/or backrest surface support that fits into a seat surface or backrest surface of the seat device. This allows the geometry of the resulting seat surface or backrest surface to be adapted to the respective purpose in the rest position. For example, the seat surface or the backrest surface can be designed with regard to safety and ergonomics during a journey. In particular, side bolsters can be provided on the seat surface or backrest surface to ensure lateral support and a predetermined seating position in relation to safety systems while driving. However, such side bolsters interfere with use if, for example, a surface that is as flat as possible is desired.

It is advantageous that at least one upholstery extension is at least partially designed as a cover, which can be arranged at least partially over a seat surface and/or a backrest surface of the seat device. This makes a reliable seat possible. It can be easily fitted and removed by the user.

It is advantageous that at least one upholstery extension is designed as a cushion that fits against a backrest of the seat device. For example, the comfort of a couch can be realised by using the cushion as an arm and head rest. In particular, it is advantageous that at least one upholstery extension is designed as a lateral cushion which is provided at least approximately next to a seat surface of the seat device.

It is advantageous that at least one upholstery extension is designed as a seat surface enlargement, which enlarges a seat surface of at least one seat device. This can improve comfort. Greater variations in the seating position are possible. If necessary, an additional person can be accommodated. People can sit at an angle or close together.

It is advantageous that the seat surface enlargement enlarges the seat surface of the seat device, at least next to the seat surface of the seat device. If necessary, at least one additional person can be accommodated. If necessary, a reclining option can be created. It may be possible to provide a place to put the feet up. It is particularly advantageous that the seat surface enlargement enlarges the seat surface of the seat device at least in front of the seat surface of the seat device.

It is advantageous that at least one upholstery extension is designed as a backrest enlargement, which enlarges the backrest surface of the seat device. It is advantageous in particular that the backrest enlargement enlarges the backrest surface of the seat device next to the backrest surface of the seat device. This allows the seating position to be varied. If necessary, space can be created for at least one more person.

It is advantageous that a first seat device is provided in the front region, which can be arranged in a driving position for driving the recreational vehicle and in at least one rest position different from the driving position, and at least one second seat device is provided in the front region, which can be arranged in a driving position for driving the recreational vehicle and in at least one rest position different from the driving position, that the first seat device and the second seat device can be arranged in the rest position in such a way that a seat surface of the first seat device and a seat surface of the second seat device are arranged next to one another at a certain distance, and that at least one upholstery extension can be arranged between the seat surface of the first seat device and the seat surface of the second seat device, so that an at least substantially uninterrupted total surface extending over the seat surface of the first seat device and the seat surface of the second seat device is formed. This makes it possible to realise additional usage options. A reclining surface can be created. The at least essentially uninterrupted total surface can be designed in such a way that it is possible to lie down comfortably, since gaps or the like that are too wide in this respect are prevented. The same applies to the realisation of a bench, couch or the like.

It is advantageous that the at least one upholstery extension is designed in such a way that the total surface can be used for a couch and/or an additional bed and/or a children's bed and/or as an emergency bed and/or as a shelf. This can also optimise the use of the floor plan, as the seats can be used multifunctionally.

It is advantageous that at least one seat device is designed as a driver's seat and/or that at least one seat device is designed as a passenger-side seat device, in particular as a passenger seat or passenger seat group. In particular, the passenger seat group can be designed for two people. This means that a larger number of additional seating options can be created, which significantly improves space utilisation.

It is advantageous that at least one seat device is designed as a rotatable seat device and/or that at least one seat device is designed as a seat device that can be rotated by at least 180°. This makes it possible in a particularly favourable manner to create a couch, a bench seat, a reclining surface or the like which extends over a large part, in particular at least substantially, over the interior width.

It is advantageous that at least one upholstery extension is designed as an at least partially inflatable upholstery extension and/or that at least one upholstery extension has at least one inflatable chamber and/or that at least one upholstery extension has at least one inflatable chamber with internal tensile elements and/or support elements. A compressor can be provided here, which enables automatic inflation and deflation. This creates a particularly convenient way of adapting to the stay.

It is advantageous that at least one upholstery extension is designed as a console. This can, for example, form a backrest piece between the driver's seat and the front passenger seat or the front passenger seat group, which preferably holds its position when in use due to its shape and bridges the seat backrest surfaces of the driver's seat and the front passenger seat or the front passenger seat group, in particular at least essentially uninterruptedly.

It is advantageous that at least one upholstery extension is designed as a foldable upholstery extension. This enables compact stowage.

It is advantageous that at least one upholstery extension is designed as a sewn upholstery extension. This means that a textile material can be used. If necessary, combinations of materials can also be used.

It is advantageous that by the at least one seat device and the at least one upholstery extension a seat group for a plurality of people, in particular a seat group for two to five people, can be formed. As a result, other permanent seat devices can be reduced or completely omitted. This optimises the space requirement in the floor plan.

It is advantageous that, by the at least one seat device and the at least one upholstery extension, a seat group comprising a temporary lateral bench seat is formed. This enables a large number of seating options and at the same time ensures great design freedom when designing the layout, in particular when positioning a side door for boarding and alighting.

Depending on the design and application, one or more of the following features and advantages may be realised.

In an advantageous way, the driver and front passenger seats can be converted into a couch. Individual rotatable driver and passenger seats can be rotated to form a table.

In one possible configuration, the driver and front passenger seats can be converted into a couch with up to 3 seats and/or converted into a children's bed or emergency bed. Versions for retrofitting in a recreational vehicle can also be realised. A shelf can be realised between the driver and front passenger seats, which can also be retrofitted if necessary. Added comfort, flexibility and improved lines of sight can be achieved.

It is possible to convert the driver and front passenger seats with swivel console into a couch and/or to connect them to a common seat and/or backrest surface using add-on parts. This allows the driver and front passenger seats to be used as a couch and/or as an additional bed, children's bed or emergency bed and/or as a shelf.

In an embodiment, a console is provided between the seats. A swivel console with a swivel limiter can also be realised. In an embodiment, a console and a cushion or a cover with a cushion section or cushion sections can be realised. In an embodiment, inflation can take place, wherein a design can be realised as a single or multi-chamber part with or without support.

By using the driver and front passenger seats as a couch, layouts with a quasi-circular seat group, which can consist of an L-shaped seat group, are possible. It is possible to convert the driver and front passenger seats. By using the driver and front passenger seats as a couch, layouts with an arrangement of a first couch and a second couch are possible, so that four people can sit opposite each other. This is particularly possible when using an upholstery extension as a single bench seat.

A possible embodiment features an inflatable configuration. Furthermore, the seat extension can also be designed as a console between the seats. All components do not necessarily have to be inflatable; they can also be designed as consoles, folding, sewn or other designs. Furthermore, any useful combinations are possible.

This makes new layouts possible. Better seating comfort can be achieved when standing after conversion to a couch. An improved feeling of space can be achieved. A 5-person seat group can be realised without an additional fixed side bench seat on the passenger side. This enables an improved room layout and new positions for the body door. In particular, a fixed side bench seat can be omitted. An improved line of sight into the motorhome and to a screen, especially a television, can be achieved.

### BRIEF DESCRIPTION OF THE DRAWINGS

Further advantages and details of the invention are explained in more detail with reference to the embodiments shown in the schematic figures. Therein:

FIG. 1 shows an excerpt from a schematic representation of a recreational vehicle according to an embodiment of the invention, with a floor plan being shown in one possible embodiment;

FIG. 2 shows the recreational vehicle shown in FIG. 1, with a floor plan of a further possible configuration being shown;

FIG. 3 shows an excerpt, schematic, spatial representation of an arrangement with a driver's seat and a passenger's seat in a rest position to explain the mode of operation of the embodiment, wherein an inflatable cover, cushions and a seat surface enlargement are shown;

FIG. 4 shows an excerpt, schematic, spatial representation of an arrangement with a driver's seat and a passenger seat in a lounge position to explain the mode of operation of the embodiment, wherein the seat surface enlargement is shown and wherein the inflatable cover and the cushions shown in FIG. 3 are not mounted; and

FIG. 5 shows an excerpt schematic, spatial representation of an arrangement with a driver's seat and a passenger seat in a rest position to illustrate the mode of operation of the embodiment, wherein a further seat surface enlargement is shown.

### DETAILED DESCRIPTION OF THE INVENTION

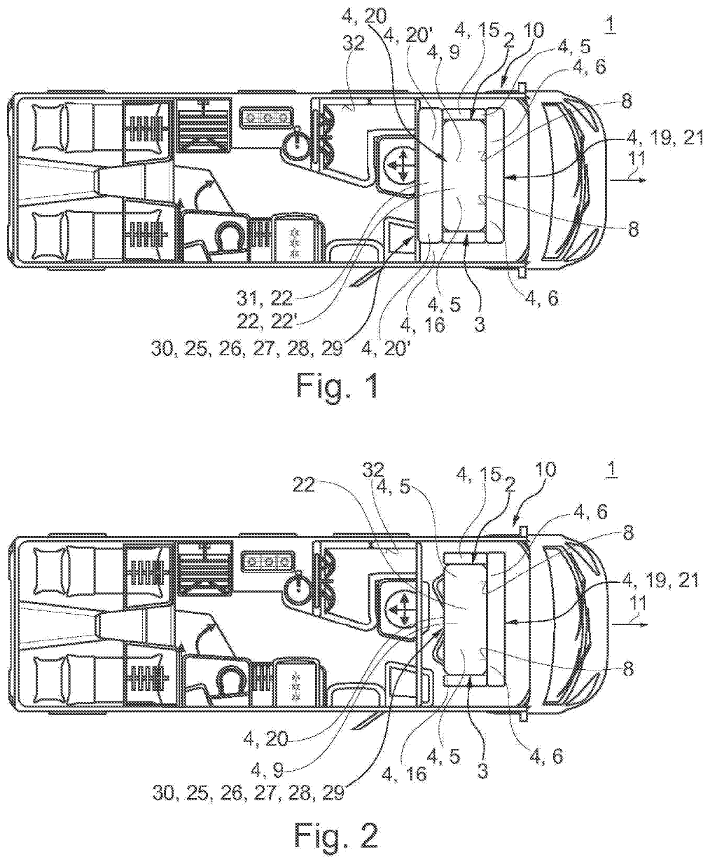

FIG. 1 shows an excerpt from a schematic representation of a recreational vehicle according to an embodiment of the invention. A floor plan is shown in one possible embodiment. The recreational vehicle 2 is preferably designed as a motorhome. The recreational vehicle 1 comprises seating facilities 2, 3, which are arranged in the front region 10 of the recreational vehicle 1. When travelling, these are arranged in a driving position so that they are oriented in the direction of travel 11.

When the recreational vehicle 1 is parked at a campsite, for example, the seating equipment can be arranged in one or more rest positions. The rest positions differ from the driving position. In the floor plan shown, the seat devices 2, 3 are arranged in rest positions in which the seat devices are orientated 180° against the direction of travel 11. The seat devices 2, 3 are each designed as rotatable seat devices 2, 3, wherein it is possible to rotate them inwards from the driving position. It is possible to lock them in any rotational position. It may also be possible to rotate by more than 180°.

In this embodiment, several upholstery extensions 4 are provided. Upholstery extensions 4 can be designed in such a way that they fit into the seat devices 2, 3 when these are each positioned in the rest position shown. The upholstery extensions 4 can be designed in different ways. FIGS. 1 to 5 illustrate possible configurations.

FIG. 2 shows the recreational vehicle 1 shown in FIG. 1, wherein a floor plan is shown in a further possible configuration. The seat devices 2, 3 can be designed as driver's seat 2 and passenger seat 3.

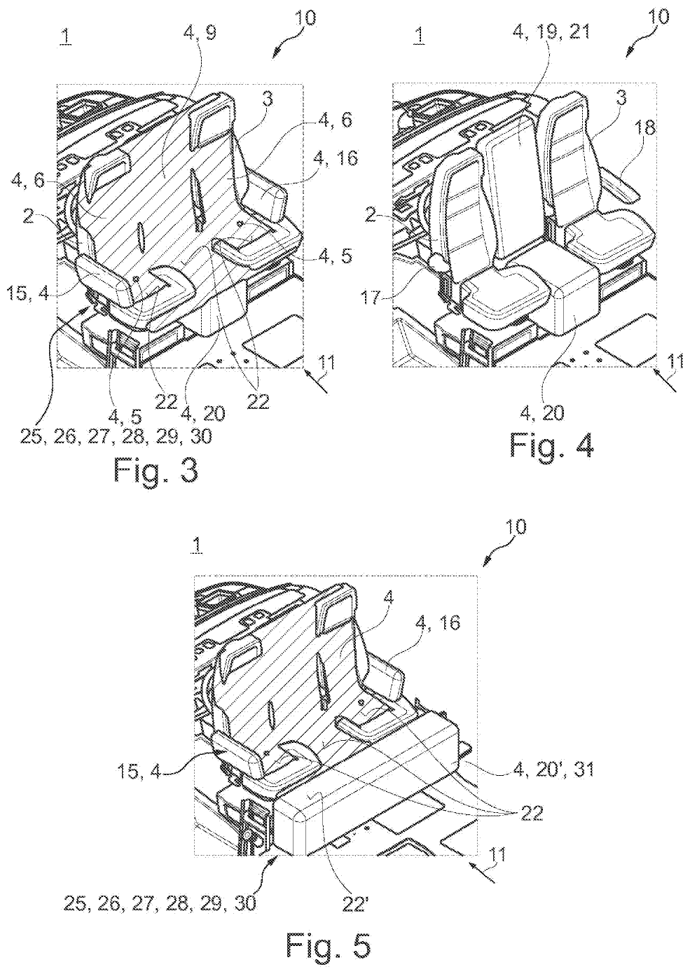

FIG. 3 shows an excerpted, schematic, spatial representation of an arrangement with a driver's seat 2 and a passenger seat 3 in the rest position to explain the mode of operation of the embodiment example. FIG. 4 shows an arrangement corresponding to FIG. 3 in an excerpted, schematic, spatial representation to explain the mode of operation of the embodiment.

In this embodiment, an upholstery extension 4 is designed as a seat surface support 5 and backrest surface support 6, which fits into the seat surfaces 7 and backrest surfaces 8 of the seat devices 2, 3, as shown in FIG. 3. For clarification, the seat surface support 5 and backrest surface support 6 are not fitted in FIG. 4. In this embodiment, the upholstery extension 4 is designed as a cover 9, which is partially pulled over the seat surfaces 7 and the backrest surfaces 8 of the seat device 2, 3 in order to realise the seat surface support 5 and backrest surface support 6.

Further upholstery extensions 4 are designed as cushions 15, 16. The cushions 15, 16 are shown in FIG. 3 and are not fitted in FIG. 4. The cushions 15, 16 are joined to the backrests 17, 18 of the seat devices 2, 3. In this embodiment example, the cushions 15, 16 are designed as lateral cushions 15, 16, which are arranged approximately next to the seat surfaces 7 of the seat devices 2, 3.

In this embodiment, a upholstery extension 4 is also designed as a seat surface enlargement 20. The seat surface enlargement 20 enlarges the seat surfaces 7 of the seat devices 2, 3 by being arranged between them. Associated with the seat surface enlargement 20 is a further upholstery extension 4 in the form of a backrest enlargement 21. The backrest enlargement 21 enlarges the backrest surfaces 8 of the seat devices 2, 3 by being arranged between them. In this embodiment, the backrest enlargement 21 is designed as a console 19. This means that additional seating space can be created between the seat units 2, 3.

Here, the seat surface 7 of the seat device 2 and the seat surface 7 of the second seat device 3 are arranged next to each other at a certain distance when they are each in the rest position. Together with the seat surface enlargement 20, this results in an at least substantially uninterrupted total surface 22 extending over the seat surface 7 of the first seat device 2 and the seat surface 7 of the second seat device 3. In this embodiment, this arrangement of the seat surfaces 7 of the seat devices 2, 3 and the seat surface enlargement 20 is still covered overall with the cover 9, so that preferably no intermediate gaps remain.

FIG. 5 shows an excerpted, schematic, spatial representation of an arrangement with a driver's seat 2 and a passenger seat 3 in an occupied position to explain the mode of operation of the embodiment, wherein a further seat surface enlargement 20′ is shown. This further seat surface enlargement 20′ is additionally arranged in front of the arrangement illustrated in FIG. 3. In one possible arrangement, the further seat surface enlargement 20′ enlarges the seat surfaces 7 of the seat devices 2, 3 in front of the respective seat surface 7 and in front of the seat surface enlargement 20.

In this embodiment, the resulting total surface 22 can be used for a couch 25 by means of several upholstery extensions 4, as illustrated in FIGS. 2 to 4. The total surface 22′ can also be used for an additional bed 26 and/or a children's bed 27 and/or an emergency bed 28, as illustrated in FIGS. 1 and 5. Furthermore, a total surface 22, 22′ can also be used as a shelf 29. Depending on the requirements, in particular with regard to the size of the total surface 22, 22′ and comfort, other uses are also possible in addition to these preferred uses.

With the inclusion of the seat devices 2, 3, for example, a seat group 30 for two to five people can be realised using the upholstery extensions 4. In an arrangement modified from that shown in FIG. 1, the seat surface enlargement 20′ can form a temporary side bench 31 for this purpose, which is placed against a side wall 32 (FIGS. 1 and 2).

The invention is not limited to the described embodiments.

1-12. (canceled)

13. A recreational vehicle, comprising:
at least one seat device in a front region of the recreational vehicle, the at least one seat device configured to be arranged in a driving position for driving the recreational vehicle and in at least one rest position different from the driving position;
at least one upholstery extension configured in such a way that the at least one upholstery extension fits into the at least one seat device at least in the rest position.

14. The recreational vehicle according to claim 13, wherein the at least one upholstery extension is designed as a seat surface support which fits into a seat surface and/or as a backrest surface support which fits into a backrest surface of the at least one seat device.

15. The recreational vehicle according to claim 13, wherein the at least one upholstery extension is at least partially designed as a cover configured to be arranged at least partially over a seat surface and/or a backrest surface of the at least one seat device.

16. The recreational vehicle according to claim 13, wherein the at least one upholstery extension is designed as a cushion which fits against a backrest of the at least one seat device and/or the at least one upholstery extension is designed as a lateral cushion which is provided at least approximately next to a seat surface of the at least one seat device.

17. The recreational vehicle according to claim 13, wherein the at least one upholstery extension is designed as a seat surface enlargement, which enlarges a seat surface of at least one seat device.

18. The recreational vehicle according to claim 17, wherein:
the seat surface enlargement enlarges the seat surface of the at least one seat device at least next to the seat surface of the at least one seat device; and/or
the seat surface enlargement enlarges the seat surface of the at least one seat device at least in front of the seat surface of the at least one seat device.

19. The recreational vehicle according to claim 13, wherein the at least one upholstery extension is designed as a backrest enlargement which enlarges a backrest surface of the at least one seat device.

20. The recreational vehicle according to claim 19, wherein the backrest enlargement enlarges the backrest surface of the at least one seat device next to the backrest surface of the at least one seat device.

21. The recreational vehicle according to claim 13, wherein the at least one seat device comprises:
a first seat device provided in the front region configured to be arranged in the driving position for driving the recreational vehicle and in the at least one rest position different from the driving position; and
at least one second seat device provided in the front region configured to be arranged in the driving position for driving the recreational vehicle and in the at least one rest position different from the driving position;
wherein the first seat device and the at least one second seat device are configured to be arranged in the rest position in such a way that a seat surface of the first seat device and a seat surface of the at least one second seat device are arranged next to one another at a certain distance; and
wherein the at least one upholstery extension is configured to be arranged between the seat surface of the first seat device and the seat surface of the at least one second seat device so that an at least substantially uninterrupted total surface extending over the seat surface of the first seat device and the seat surface of the at least one second seat device is formed.

22. The recreational vehicle according to claim 21, wherein the at least one upholstery extension is configured such that the total surface can be used for a couch and/or an additional bed and/or a children's bed and/or as an emergency bed and/or as a shelf.

23. The recreational vehicle according to claim 13, wherein the at least one seat device configured as a driver's seat, a passenger-side seat device, a passenger seat or as a passenger seat group.

24. The recreational vehicle according to claim 13, wherein the at least one seat device is a rotatable seat device and/or is rotatable through at least 180°.

25. The recreational vehicle according to claim 13, wherein the at least one upholstery extension is an at least partially inflatable upholstery extension and/or has at least one inflatable chamber and/or has at least one inflatable chamber with internal tensile elements and/or support elements.

26. The recreational vehicle according to claim 13, wherein the at least one upholstery extension is selected from the group consisting of a console, as a foldable upholstery extension, a sewn upholstery extension and combinations thereof.

27. The recreational vehicle according to claim 13, wherein the at least one seat device and the at least one upholstery extension cooperate to define a seat group selected from the group consisting of a seat group for a plurality of persons, a seat group for two to five persons, and a temporary lateral bench seat.

28. The recreational vehicle according to claim 13, wherein the recreational vehicle is a motorhome.

29. A recreational vehicle, comprising:
a first seat device provided in the front region configured to be arranged in a driving position for driving the recreational vehicle and in at least one rest position different from the driving position; and
at least one second seat device provided in the front region configured to be arranged in a driving position for driving the recreational vehicle and in at least one rest position different from the driving position;
wherein the first seat device and the at least one second seat device are configured to be arranged in the rest position in such a way that a seat surface of the first seat device and a seat surface of the at least one second seat device are arranged next to one another at a certain distance;
at least one upholstery extension configured, at least in the rest position, to be arranged between the seat surface of the first seat device and the seat surface of the at least one second seat device so that an at least substantially uninterrupted total surface extending over the seat surface of the first seat device and the seat surface of the at least one second seat device is formed; and
the at least upholstery extension further being at least partially designed as a cover configured to be arranged at least partially over the seat surface and/or the backrest surface of the first and second seat device.

30. The recreational vehicle according to claim 29, further comprising a further seat enlargement configured to be disposed adjacent a front of the seat surface of the first and second seat devices so as to enlarge the total surface provided by the first and second seat device and the at least one upholstery extension.
